(19) United States
(12) Patent Application Publication
(10) Pub. No.: US 2012/0071310 A1
(43) Pub. Date: Mar. 22, 2012

(54) Sheet folding device and image forming apparatus

(75) Inventor: Toshikazu SATOH, Aichi (JP)

(73) Assignee: Ricoh Company, Limited, Tokyo (JP)

(21) Appl. No.: 13/137,840

(22) Filed: Sep. 16, 2011

(30) Foreign Application Priority Data
Sep. 21, 2010 (JP) 2010-210999

(51) Int. Cl. B31F 7/00

(52) U.S. Cl. 493/442

(57) ABSTRACT

A sheet folding device includes: a conveying path to convey a sheet; a conveying unit to convey the sheet to downstream in a sheet conveying direction; a folding-conveying path branching from the conveying path downstream of the conveying unit in the sheet conveying direction to discharge a folded sheet; a pair of folding rollers arranged in a branching portion of the folding-conveying path to fold the sheet in a nip formed between the rollers; a leading end stopper on which a leading end of the sheet is abutted to determine a folding position; an angle adjustment unit that adjusts an angle of the leading end stopper; a folding-length measurement unit to measure lengths of both edges of the sheet; and a control unit that operates the angle adjustment unit based on the measurement result of the folding-length measurement unit to variably control the angle of the leading end stopper.

### CROSS-REFERENCE TO RELATED APPLICATIONS

The present application claims priority to and incorporates by reference the entire contents of Japanese Patent Application No. 2010-210999 filed in Japan on Sep. 21, 2010.

### BACKGROUND OF THE INVENTION

1. Field of the Invention

The present invention relates to a sheet folding device for folding a sheet-like recording medium (hereinafter, referred to as a “sheet”), such as paper, transfer paper, recording paper, a film-like member, or folds a bunch of paper. The invention further relates to an image forming apparatus having the sheet folding device, such as a copying machine, a printer, a facsimile, and a digital multi-function peripheral (MFP) having these functions.

2. Description of the Related Art

In connection with a sheet folding device used as a peripheral of an image forming apparatus, various types of finishers have been proposed for performing a variety of processing, such as post-processing or the like on sheets. The post-processing includes a variety of processing, such as punching, alignment, sorting, binding, and folding. Punching refers to making a hole in a sheet on the process of sheet conveyance. Alignment refers to align the edges of a bunch of sheets in both the conveying direction and the widthwise direction. Sorting refers to shift the locations of small bunches of sheets, thereby to clearly assort bunches from one other. Binding refers to stapling the aligned sheet bunch at an edge part or a central part. Folding includes single folding, triple folding (Z-folding), quadruple folding, gate folding, and the like. In this finisher, as a sheet folding device of the related art which performs a sheet folding process on the sheets, there is known a sheet folding device for performing a folding process in such a manner that a leading end of the sheet is brought into contact with a stopper so that the sheet forms a loop, and the loop of the sheet is nipped with folding rollers so as to form a fold mark on the sheet.

For example, Japanese Patent Application Laid-open No. H10-194587 discloses an exemplary sheet folding device. According to Japanese Patent Application Laid-open No. H10-194587, in order to accurately form a fold mark regardless of the sheet conveying conditions, the sheet folding device includes: a stopper on which the leading end of a sheet conveyed abuts so as to form a loop in the sheet; a folding roller that makes a fold mark on the sheet by nipping the loop; and a pair of rotatable and stoppable registration rollers arranged in the upstream from the nip portion for nipping the loop. According to this invention, the leading end of the sheet which has been conveyed abuts on the pair of registration rollers before abutting on the stopper. Therefore, the leading end of the sheet which has been conveyed with an inclination abuts on the stopper after being aligned by the pair of registration rollers to correct the inclination of the sheet.

As described above, in the sheet folding device of the related art, the sheet is nipped by the folding roller right after the leading end of the conveyed sheet abuts on the stopper. Therefore, for example, in a case where the sheet is conveyed with an inclination larger than a predetermined reference value, it is difficult to correct the inclination perfectly only by causing the sheet leading end to abut on the stopper. As a result, there is a problem in that the resulting fold mark is inclined accordingly.

In addition, in a case where the sheet is conveyed with a small inclination as compared with a predetermined reference value, or in a case where the stopper is inclined due to a manufacturing variation or the like, there is a problem in that the resulting fold mark is accordingly inclined in spite of an effort to correct the inclination using the registration roller as in Japanese Patent Application Laid-open No. H10-194587.

Furthermore, if there is an inclination in the stopper due to a manufacturing variation, it is necessary to manually correct the inclination by means of fine adjustment. Further, if there is an inclination due to vibration during delivery, it is also necessary to perform a similar manual work at the time of product arrival.

### SUMMARY OF THE INVENTION

It is an object of the present invention to at least partially solve the problems in the conventional technology.

According to an aspect of the present invention, there is provided a sheet folding device including: a conveying path on which a sheet is conveyed; a conveying unit arranged on the conveying path to convey the sheet to the downstream side in a sheet conveying direction of the conveying path; a folding conveying path branching from the conveying path in a downstream side of the conveying unit in the sheet conveying direction to discharge a folded sheet; a pair of folding rollers arranged in a branching portion of the folding-conveying path branching from the conveying path to fold the sheet in a nip formed between the rollers; a leading end stopper which is arranged in a downstream from the folding roller in the sheet conveying direction and on which a leading end of the sheet is abutted to determine a folding position; an angle adjustment unit that adjusts an angle of the leading end stopper; a folding-length measurement unit arranged in the folding-conveying path to measure each length of both edges of the sheet that passes therethrough; and a control unit that operates the angle adjustment unit based on the measurement result of the folding-length measurement unit to variably control the angle of the leading end stopper.

According to another aspect of the present invention, there is provided an image forming apparatus including the sheet folding device. The sheet folding device includes a conveying path on which a sheet is conveyed; a conveying unit arranged on the conveying path to convey the sheet to the downstream side in a sheet conveying direction of the conveying path; a folding conveying path branching from the conveying path in a downstream side of the conveying unit in the sheet conveying direction to discharge a folded sheet; a pair of folding rollers arranged in a branching portion of the folding-conveying path branching from the conveying path to fold the sheet in a nip formed between the rollers; a leading end stopper which is arranged in a downstream from the folding roller in the sheet conveying direction and on which a leading end of the sheet is abutted to determine a folding position; an angle adjustment unit that adjusts an angle of the leading end stopper; a folding-length measurement unit arranged in the folding-conveying path to measure each length of both edges of the sheet that passes therethrough; and a control unit that operates the angle adjustment unit based on the measurement result of the folding-length measurement unit to variably control the angle of the leading end stopper.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a basic configuration of a sheet folding device according to a first embodiment of the invention;

FIG. 2 is a schematic diagram illustrating a pair of folding rollers as a basic configuration of the folding unit;

FIG. 3 is a schematic diagram illustrating a pair of folding rollers as a configuration of a folding unit for performing a folding process by removing a bending assisting member from the model of FIG. 2;

FIG. 4 is a diagram illustrating the entire configuration of a leading end stopper and a leading end stopper angle adjusting driver of FIG. 1;

FIG. 5 is a perspective view illustrating the leading end stopper;

FIG. 6 is a diagram illustrating a state in which the base is rotated counterclockwise using the base angle adjustment driving actuator, and the leading end stopper is arranged to raise the right side in the front view;

FIG. 7 is a diagram illustrating a state in which the base is rotated clockwise using the base angle adjustment driving actuator, and the leading end stopper is arranged to be lowered to the right side in the front view;

FIG. 8 is a flowchart illustrating an operation sequence for controlling an angle of the leading end stopper;

FIG. 9 is a plan view illustrating a relation between a folded sheet and a pair of folding-length measurement units;

FIGS. 10A and 10B are explanatory diagrams illustrating an inclination of the folded sheet in the folding unit and a correction method thereof;

FIG. 11 is a flowchart illustrating an operation sequence according to a second embodiment by controlling an angle and a position of the leading end stopper;

FIGS. 12A to 12C are explanatory diagrams illustrating a relation between the folding-length and the leading end stopper;

FIG. 13 is a flowchart illustrating an operation sequence according to a third embodiment, in which the controlling of a type of the folding mode is added to the controlling of the angle and the position of the leading end stopper;

FIGS. 14A and 14B are explanatory diagrams illustrating the state of a deviation in the third embodiment;

FIG. 15 is a flowchart illustrating a process sequence according to a fourth embodiment, in which different control operations are performed depending on whether or not a folding-length adjustment mode is selected by a user; and

FIG. 16 is a diagram illustrating a schematic configuration of the specific sheet folding device according to a fifth embodiment.

### DETAILED DESCRIPTION OF THE PREFERRED EMBODIMENTS

The present invention is characterized by the controlling system of an inclination of a stopper, on which a leading end of a sheet in a sheet folding unit is abutted, is controlled based on the result of measurement of a folding length. Hereinafter, embodiments of the invention will be described with reference to the accompanying drawings.

In the embodiments described below, a reference symbol P denotes a sheet, and a reference numeral 220 denotes a conveying path. A conveying unit corresponds to a carriage roller 202. A reference numeral 221 denotes a folding conveying path. A reference numeral 201 (201a and 201b) denotes a pair of folding rollers. A reference numeral 204 denotes a leading end stopper. An angle adjustment unit corresponds to a leading end stopper angle adjusting driver 210. A reference numeral 209 (209a and 209b) denotes a folding-length measurement unit. A control means corresponds to a control unit 200. A position adjustment unit corresponds to a leading end stopper position adjusting driver 205. A reference numeral 206 denotes a leading end detector, a reference numeral 100 denotes a sheet folding device, and a reference symbol PR denotes an image forming apparatus.

### First Embodiment

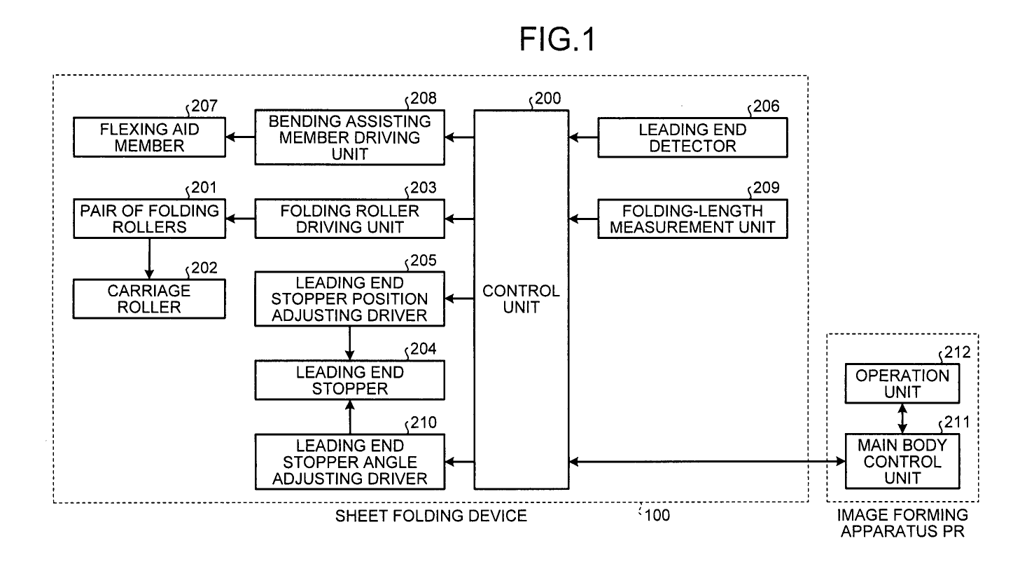

FIG. 1 is a functional block diagram illustrating a basic configuration of a sheet folding device according to a first embodiment. Referring to FIG. 1, the sheet folding device 100 functionally includes: a pair of folding rollers 201 to fold a sheet; a carriage roller 202 which rotates along with the driving of the pair of folding rollers 201 to thereby convey the sheet; a folding roller driving unit 203 which drives the pair of folding rollers 201; a leading end stopper 204 on which the leading end of the sheet abuts to determine a folding position; a leading end stopper position adjusting driver 205 that adjusts the position of the leading end stopper 204; a leading end detector 206 that detects the leading end of the sheet; a bending assisting member 207 that guides a folding position of the sheet to a nip of the pair of folding rollers 201 based on the detection signal from the leading end detector 206; a bending assisting member driving unit 208 that drives the bending assisting member 207; a folding-length measurement unit 209 that measures a length of the folded sheet; a leading end stopper angle adjusting driver 210 that adjusts the angle of the leading end stopper 204 based on a signal output from the folding-length measurement unit 209; and a control unit 200 that controls each of the driving units 203, 205, 208, and 210 based on at least one of the signal inputs from the leading end detector 206 and the folding-length measurement unit 209.

The sheet folding device 100 is connected to an image forming apparatus PR. A main body control unit 211 of the image forming apparatus PR and the control unit 200 of the sheet folding device 100 are connected to each other so as to be able to communicate with each other. A main operation unit 212 for selecting leading end stopper angle adjustment mode is connected to the main body control unit 211, and the main body control unit 211 controls the control unit 200 of the sheet folding device 100 according to instructions from the operation unit 212.

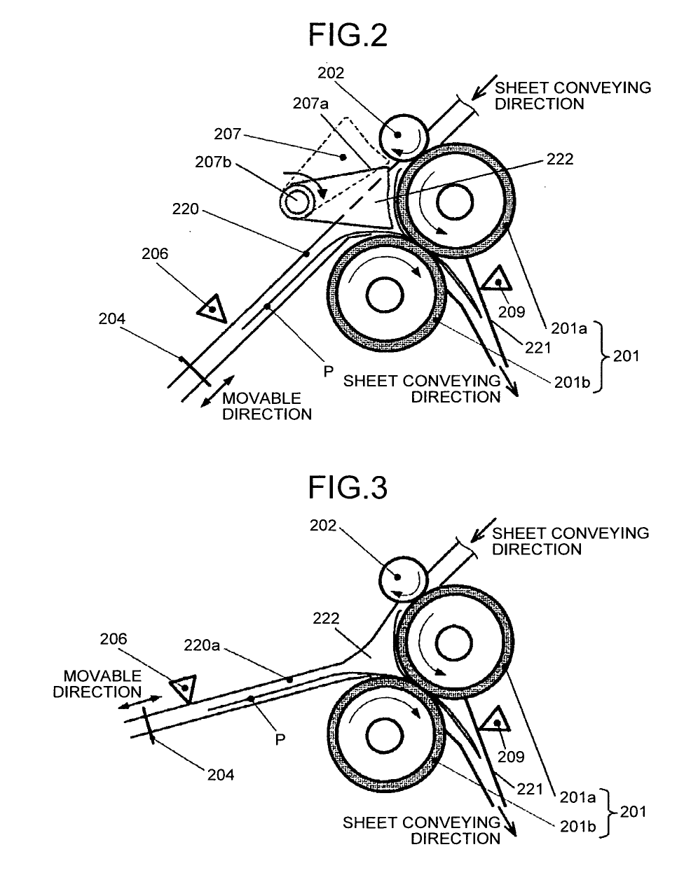

FIG. 2 is a schematic diagram illustrating a pair of folding rollers and illustrating the basic structure (layout) of the folding unit. Referring to FIG. 2, a conveying path 220 is provided in a straight line, a folding conveying path 221 is connected to the conveying path 220 in an approximately perpendicular direction, and the pair of folding rollers 201 is arranged at a connected portion thereof. The pair of folding rollers 201 includes a first folding roller 201a located in the upstream in the sheet conveying direction and a second folding roller 201b located in the downstream of the sheet conveying direction. The folding position of a sheet P is inserted into a nip between the folding rollers 201a and 201b so as to fold the sheet at a central part of the sheet.

To the first folding roller 201a, the carriage roller 202 is arranged across the conveying path 220, and a conveying force is provided by nipping the sheet P therebetween. The conveying path 220 has an opening in the upstream from the nip of the pair of folding rollers 201 and a space 222 is formed in front of the nip. In the space 222, a pivotable end 207a of the bending assisting member 207 is arranged to be able to move back and forth. The bending assisting member 207 is supported in a pivotable manner by a driving shaft 207b provided outside the conveying path 220, and the pivotable end 207a moves back and forth by driving the driving shaft 207b in a pivoting manner.

In the downstream from the second folding roller 201b in the conveying path 220, the leading end detector 206 and the leading end stopper 204 are provided. The leading end detector 206 is provided with, for example, an optical transmissive sensor or an optical reflective sensor to optically detect the passage of the sheet P. The leading end stopper 204, on which the leading end of the sheet P abuts, controls the leading end position of the sheet P. The leading end stopper 204 can move toward the sheet conveying direction, is moved to a predetermined position by the leading end stopper position adjusting driver 205 and stops at the corresponding position. The leading end stopper position adjusting driver 205 moves the leading end stopper 204 to the predetermined position based on instructions from the control unit 200 in accordance with a sheet size and a folding type. Because the leading end stopper 204 moves to determine the position based on a sheet size or a folding position, a stepping motor that does not need a position sensor and that can be controlled with a pulse alone (using so-called open-loop control) is preferably used as a driving source of the leading end stopper position adjusting driver 205. In addition, because it is difficult to install the leading end detector 206 to fit the position of the leading end stopper 204 of which a stopping position changes depending on the sheet size or the folding position, the leading end detector 206 is arranged to be out of the movable range of the leading end stopper 204.

In the vicinity of an exit of the nip between the pair of folding rollers 201, a pair of folding-length measurement units 209 (209a and 209b) is arranged to measure the folding length by detecting the leading end and trailing end of the sheet P folded by the pair of folding rollers 201. Also in this case, an optical transmissive sensor or an optical reflective sensor may be used, for example, to detect the leading end and trailing end.

In general, the sheet folding unit configured as described above performs a sheet folding process as follows.

That is, as a sheet is fed into the conveying path 220, the sheet P is further conveyed to the downstream side by the first folding roller 201a in the driving side and the carriage roller 202. As the driving source of the pair of folding rollers 201, for example, a DC brushless motor or a stepping motor may be used. The sheet P passes through the leading end detector 206 and abuts on the leading end stopper 204 which blocks the conveying path 220. Even after the sheet P abuts on the leading end stopper 204, the first folding roller 201a and the carriage roller 202 rotate in the direction indicated by the arrow in the drawing to further convey the sheet P. As a result, the sheet P starts to bend in the vicinity of the space 222 in front of the nip between the pair of folding rollers 201.

The bending assisting member 207 is triggered by the detection signal from the leading end detector 206 to rotate at predetermined timing in the direction (clockwise) indicated by the arrow in the drawing so that the bended portion of the sheet P is pressed, and the sheet P is forcibly inserted into the nip between the pair of folding rollers 201. This state corresponds to the position indicated by the solid line in FIG. 2. A solenoid or a stepping motor may be used, for example, as the driving source of the driving shaft 207b of the bending assisting member 207. When the sheet P is forcibly inserted into the nip between the pair of folding rollers 201 and the sheet folding is initiated by the pair of folding rollers 201, the bending assisting member 207 is rotated counterclockwise so as to move to the original position as indicated by the dotted line, and is evacuated from the conveying path 220.

The timing when the sheet p abuts on the leading end stopper 204 can be calculated based on the conveying length between the leading end detector 206 and the leading end stopper 204, and the linear velocity of the sheet (sheet conveying speed). For this reason, the timing when the sheet P starts to bend is also calculated, and based on the timing, the bending assisting member 207 is driven to forcibly insert the sheet P into the nip of the pair of folding rollers 201.

The time period elapsing from the leading end detecting timing to the trailing end detecting timing of the sheet P is measured by transmitting the sheet P output from the pair of folding rollers 201 through the arrangement position of the folding-length measurement unit 209 arranged near the exit of the nip of the pair of folding rollers 201. The leading end stopper angle adjusting driver 210 adjusts the angle of the leading end stopper 204 based on the result of the measurement for the time period as described below. The adjustment of the angle is performed through the instructions from the control unit 200.

In the example of FIG. 2, the bending assisting member 207 is provided to guide the folding position of the sheet P to the pair of folding rollers 201 on the straight conveying path 220. However, the bending assisting member 207 may be dispensable if a conveying path 220a is bended as shown in FIG. 3 to allow the sheet P to be naturally bended and guided to the space 222 in front of the nip of the pair of folding rollers 201.

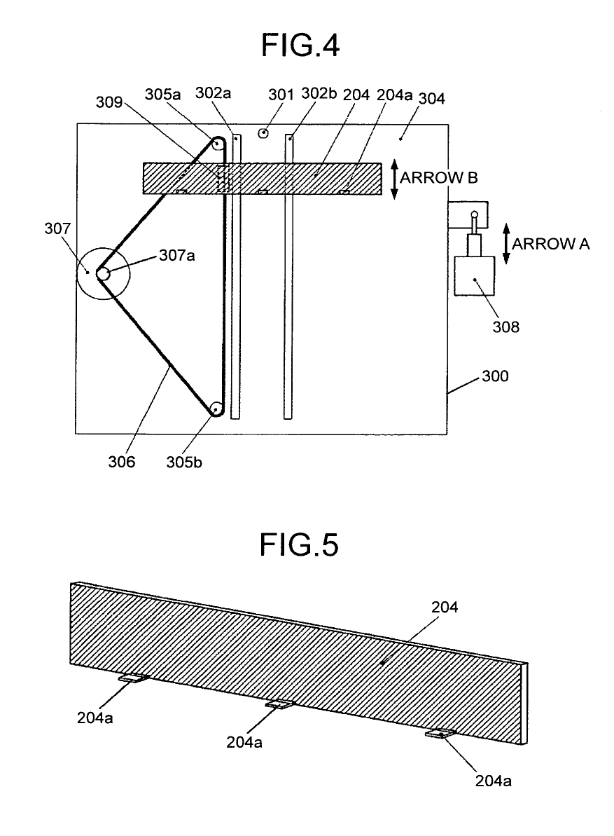

FIG. 4 is a diagram illustrating the entire configuration of the leading end stopper angle adjusting driver 210 and the leading end stopper 204 in FIG. 1. That is, FIG. 4 is a plan view illustrating the conveying path 220 of FIG. 2 as seen from the arrangement side of the bending assisting member 207. Hereinafter, the configuration of FIG. 4 will be referred to as a leading end stopper angle adjuster, and its configuration and operation will be described.

A leading end stopper angle adjuster 300 includes a base shaft 301 and a base 304 pivotably supported about the base shaft 301. The base 304 is provided with leading end stopper movable rails 302a and 302b, a driving motor 307, and belt support rollers 305a and 305b. In addition, according to the embodiment, the base 304 is arranged on the side of the leading end detector 206 to the conveying path 220 of FIG. 2 and on the side of the leading end detector 206 on the conveying path 220a in FIG. 3. However, the base 304 may be arranged on the opposite side of the leading end detector 206 on the conveying path 220a in FIG. 3. A driving roller 307a is axially located to the driving shaft of the driving motor 307, and a belt 306 is stretched around the driving roller 307a and the belt support rollers 305a and 305b. The leading end stopper 204 is fixed to the belt 306 by a fixing member 309, and the leading end stopper 204 is caused, via the belt 306, to slide by the rotation of the driving motor 307 along the leading end stopper movable rails 302a and 302b in the direction indicated by the arrow. In addition, the base 304 is pivoted about the base shaft 301 as a base angle adjusting driver 308 is actuated in the direction indicated by the arrow A, so that the angle of the leading end stopper 204 can be adjusted. As the base angle adjusting driver 308, for example, a unidirectional actuator may be used.

FIG. 5 is a perspective view illustrating the leading end stopper 204. According to the embodiment, three leading end stopper claws 204a on which the sheet P abuts are provided at the edge of the leading end stopper 204. However, the spacing and the number of claws are not limited thereto as long as their interval allowing the edge thereof to abut on the edge of the sheet can be guaranteed according to the type of the paper of the product.

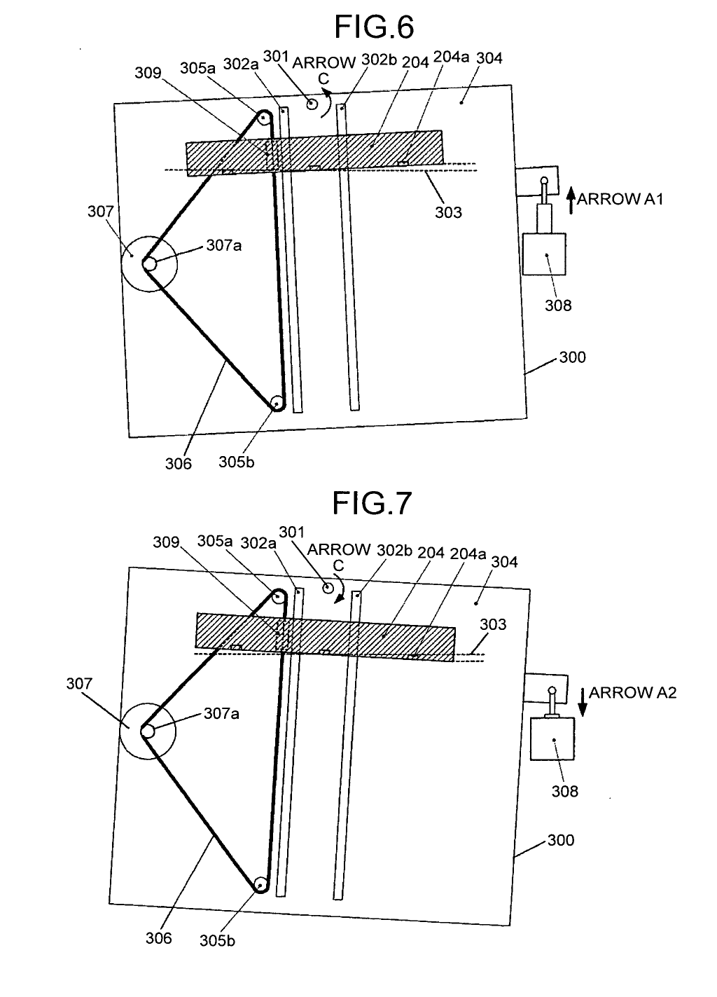

FIG. 6 illustrates a state that the base 304 is rotated counterclockwise about the base shaft 301 as the base angle adjusting driver 308 is extended in the direction indicated by the arrow Al so that the leading end stopper 204 is inclined in the counterclockwise direction from a reference line 303 (to raise the right side in the front view).

Meanwhile, FIG. 7 illustrates a state that the base 304 is rotated clockwise about the base shaft 301 by drawing (reducing) the base angle adjusting driver 308 in the direction indicated by the arrow A2 so that the leading end stopper 204 is inclined in the clockwise direction from the reference line 303 (to be lowered to the right side in the front view).

As the driving motor 307 for driving the belt 306 is driven in the clockwise direction as shown in the drawing, the leading end stopper 204 moves downwardly along the driving of the belt 306. As the driving motor 307 is driven in the counterclockwise direction as shown in the drawing, the leading end stopper 204 moves upwardly. The position of the leading end stopper 204 changes according to the sheet size or the folding type as described above. The change of the position is performed by the leading end stopper position adjusting driver 205 that controls driving of the driving motor 307 through the instructions from the control unit 200.

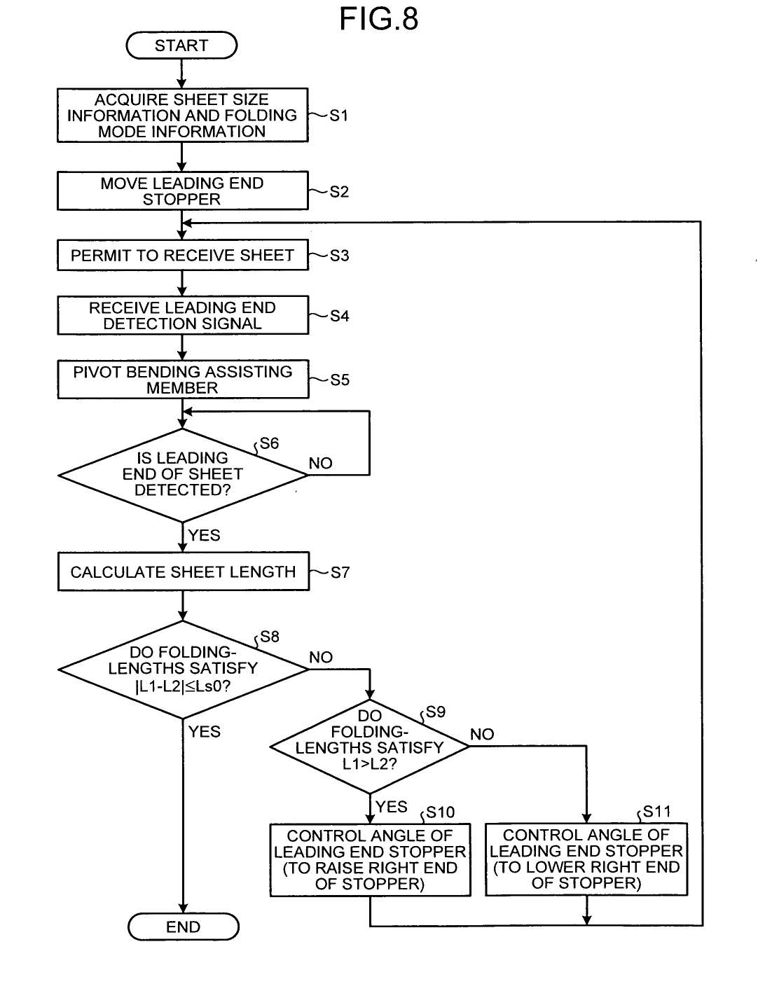

FIG. 8 is a flowchart illustrating an operation sequence for controlling the angle of the leading end stopper. The flowchart provides a processing example for a first folding unit, in which the folding mode is Z-folding, and the sheet size is A3. In addition, as will be described below, the Z-folding operation is a technique of folding the sheet twice in a Z-shape in a side view.

First, sheet information (sheet size: A3) and folding mode information (Z-folding) are acquired from the main body control unit 211 of the image forming apparatus PR (step S1). The first folding position based on the sheet information (sheet size: A3) and the folding mode information (Z-folding) is set to ¼ from the leading end of the longitudinal side of the A3 sheet. Therefore, the leading end stopper 204 is moved by driving the driving motor 307 so that a distance between the leading end stopper 204 and the nip of the pair of folding rollers 201 becomes ¼ of the longitudinal side of the A3 sheet (step S2). Then, the control unit 200 transmits a permission signal for receiving sheet to the main body control unit 211 (step S3).

If the sheet P is conveyed from the main body of the image forming apparatus PR to the sheet folding device 100, and the leading end detector 206 detects the leading end of the sheet, a signal for notifying the detection is output, and the control unit 200 receives the leading end detection signal (step S4). The control unit 200 is triggered by the leading end detection signal to pivot the driving shaft 207b of the bending assisting member 207 at the optimal timing (step S5). As a result, the sheet is guided to the nip between the pair of folding rollers 201, and conveyed to the folding conveying path 221 in the downstream from the pair of folding rollers 201.

When the sheet P passes through the pair of folding rollers 201 and the leading end of the sheet is detected by the folding-length measurement unit 209 arranged near the nip exit of the pair of folding rollers 201 (Yes in step S6), the leading end detection signal for the folded sheet P is triggered to perform the sheet length computation process to calculate the length of the sheet (step S7). In the computation process, a time period T [sec] between the detection of the leading end and the trailing end of the sheet P by the folding-length measurement unit 209, and the folding length L[mm] is calculated using the equation L=T x V, where the time period T is measured as above and the linear velocity V is assumed to have a known value V [mm/sec] during the conveyance.

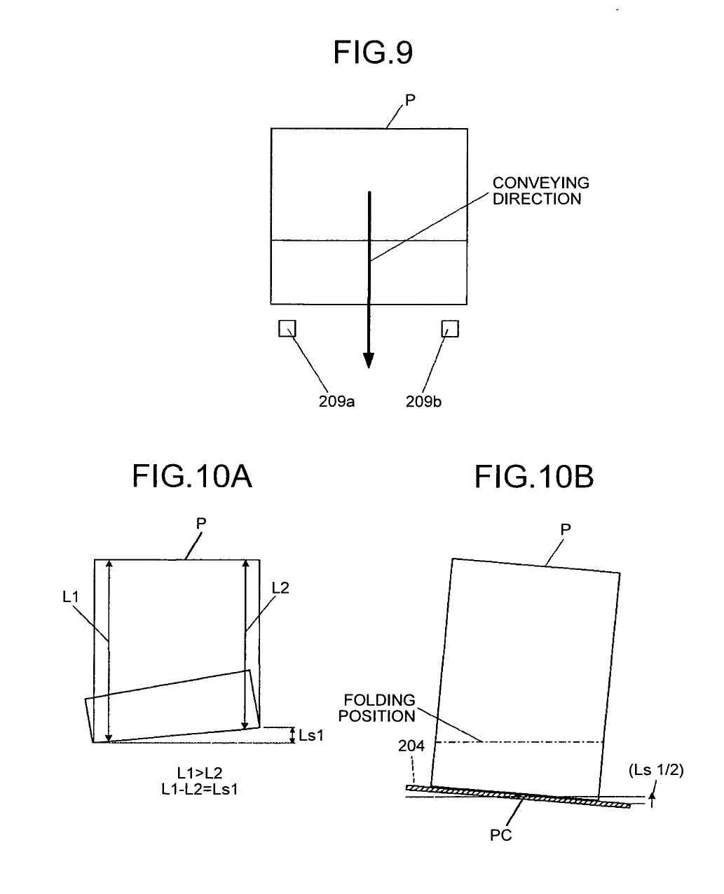

The folding-length measurement units 209 are arranged on both edges of the folding conveying path 221 through which the sheet P passes as shown in FIG. 9. Passing timing of the leading end and that of the trailing end are measured using each of the folding-length measurement units 209a and 209b in the front and back sides of the device, and the sheet folding length L1 in the front side and the sheet folding length L2 in the back side are computed. FIG. 9 is a plan view illustrating a relation between the folded sheet P and the folding-length measurement units 209a and 209b.

Each of the folding-length measurement units 209a and 209b in the front side and back side, respectively, is arranged in the folding conveying path 221 to measure a length of each side of the passing sheet. Therefore, the folding-length measurement units 209a and 209b are arranged in positions capable of detecting both edges of a sheet with the minimum size admitted by the sheet folding device 100. Depending on the sheet size, three or more of the folding-length measurement units may be provided, and the folding-length measurement unit may be configured to be movable in accordance with the sheet size.

Then, taking the difference between both folding lengths L1 and L2, and if the absolute value of the difference is equal to or smaller than a reference value Ls0 (Yes in step S8), the process is terminated. On the contrary, if the absolute value of the difference between the folding lengths L1 and L2 is larger than the reference value Ls0 (No in step S8), the folding lengths L1 and L2 are compared to examine which one is longer than the other (step S9). If the inequality

L1>L2

holds (Yes in step S9), the inclination of the leading end stopper 204 is controlled to raise the right side in the front view to reduce the L1 (step S10). Here, as shown in FIG. 10A, if the relation

L1−L2=Ls1 (Ls1>Ls0)

holds, the leading end stopper angle adjusting driver 210 may be controlled such that the right end of the leading end stopper is raised by

Ls1/2

relative to the reference line 303 passing through the center PC of the leading end of the sheet P in the conveying direction, as shown in FIG. 10B.

Meanwhile, if the inequality

L1<L2

holds (No in step S9), the inclination of the leading end stopper 204 is controlled so that the right end is lowered to lead to the reduction of L2 (step S11).

Here, if the relation

L2−L1=Ls2 (Ls2>Ls0)

holds, the leading end stopper angle adjusting driver 210 may be controlled such that the right end of the leading end stopper is lowered by

Ls2/2

relative to the reference line 303 passing through center PC of the leading end of the sheet P in the conveying direction (refer to FIG. 7).

Then, the receipt of the next sheet is permitted (step S3), and each process subsequent to the step S4 is performed again. FIGS. 10A and 10B are explanatory diagrams illustrating an inclination of the folding unit of the folded sheet and a correction method thereof.

Here, the accuracy in measuring the folding length will be described. Assuming that T[sec] denotes a time period, measured by the folding-length measurement unit 209, from the detection of the leading end until the detection of the trailing end, V[mm/sec] denotes a linear velocity, L[mm] denotes a folding length, t[ms] denotes a measuring period using the folding-length measurement unit, and l denotes a folding length that is measurable with the measuring period t, the folding length L can be expressed as

L(l)=V×T(t).

For example, if V=100 mm/sec, and t=1 ms,

l=0.1 mm (1)

For example, if V=400 mm/sec, and t=1 ms,

L=0.4 mm (2)

If t=0.25 ms,

l=0.1 mm (3)

As such, if the measuring period (t) is set to be constant, depending on the linear velocity of the sheet P, the accuracy of measurement varies between the values of equations (1) and (2). In this regard, it is understood that, in order to keep the accuracy of the measurement unchanged, the measuring period (t) may be changed depending on the linear velocity V using the values obtained by the equations (1) and (3).

As described above, according to the present embodiment, the angle of the leading end stopper 204 is variably controlled based on the measurement result of the folding-length measurement unit 209. Therefore, folding the sheet can be performed at an accurate position without being influenced by the deviation of the angle. In this case, because a manual work for folding the sheet at a desired position, for example, a work for adjusting the angle of the leading end stopper by determining, for example, the stopper angle and fixing a screw is dispensable, it is possible to improve convenience. If the stopper is inclined due to a manufacturing variation and the like, the resultant folding mark may also be inclined. In a case where the stopper has an inclination due to a manufacturing variation, the stopper is manually finely adjusted. In a case where the stopper has an inclination due to vibration during delivery, a cumbersome manual work may also be performed at the time of product arrival. According to the invention, it is possible to resolve these kinds of the problems.

### Second Embodiment

The angle of the leading end stopper is variably controlled based on the measurement result of the folding-length measurement unit according to the first embodiment. However, the second embodiment relates to an example in which the position of the leading end stopper is controlled based on the measurement result of the folding-length measurement unit in addition to the variable control for the angle of the leading end stopper in the first embodiment. Because the mechanical and electrical configurations are similar to those of the first embodiment, the same reference numerals are assigned to the same elements, and description thereof will not be repeated.

Similarly to the first embodiment, the second embodiment relates to a first folding unit, where the folding mode is set to Z-folding, and the sheet size is set to A3.

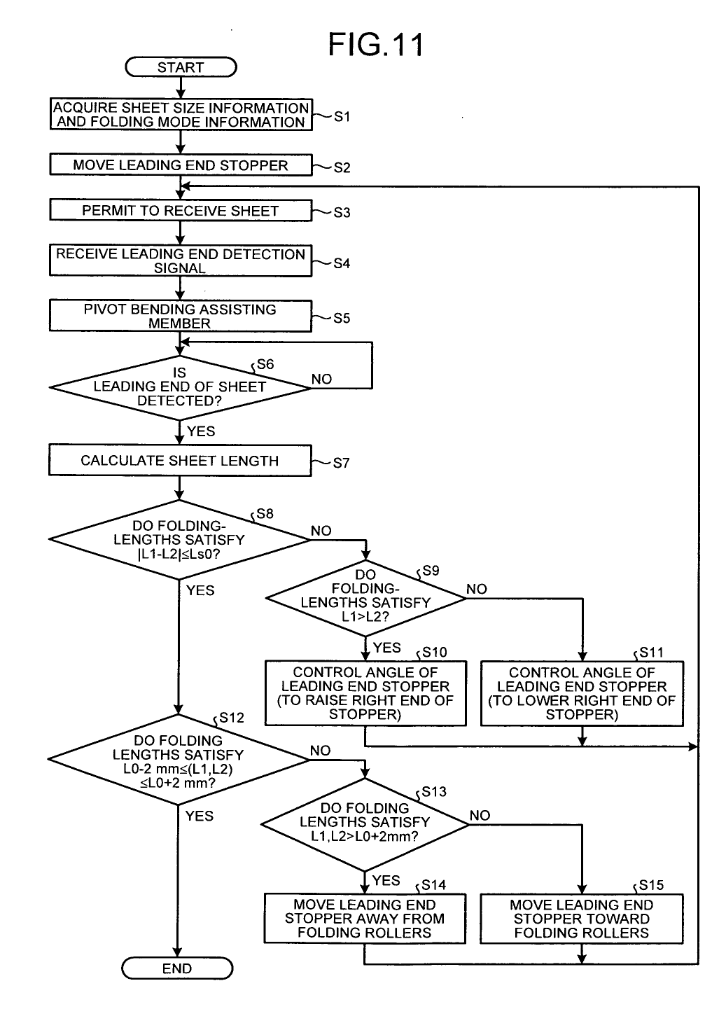

FIG. 11 is a flowchart illustrating an operational sequence of the second embodiment, in which steps S1 to S11 are similar to those of the first embodiment of FIG. 8, and description thereof will not be repeated.

Steps S1 to S8 are processed, and an absolute value of the difference between the folding lengths L1 and L2 is obtained in step S8. If the difference between the folding lengths L1 and L2 is equal to or smaller than the reference value Ls0 (Yes in step S8), it is determined whether or not the folding lengths L1 and L2 are within a reference range “L0±2 mm” (step S12). That is, it is determined whether or not the inequalities

L0−2 mm≦(L1 or L2)≦L0+2 mm

are satisfied. Here, L0 denotes ¾ of the longitudinal length of the A3 sheet, that is, 315 mm. As for the folding-length L0 which is originally expected, if the folding lengths L1 and L2 are determined to be within the range of a reference value “L0±2 mm” as a result of the determination at step S12, the process is terminated.

On the contrary, when the folding length L1 or L2 exceeds the reference value “L0±2 mm” (No in step S12), each of the folding lengths L1 and L2 is compared with the reference value “L0+2 mm” as

L1, L2>L0+2 mm (step S13).

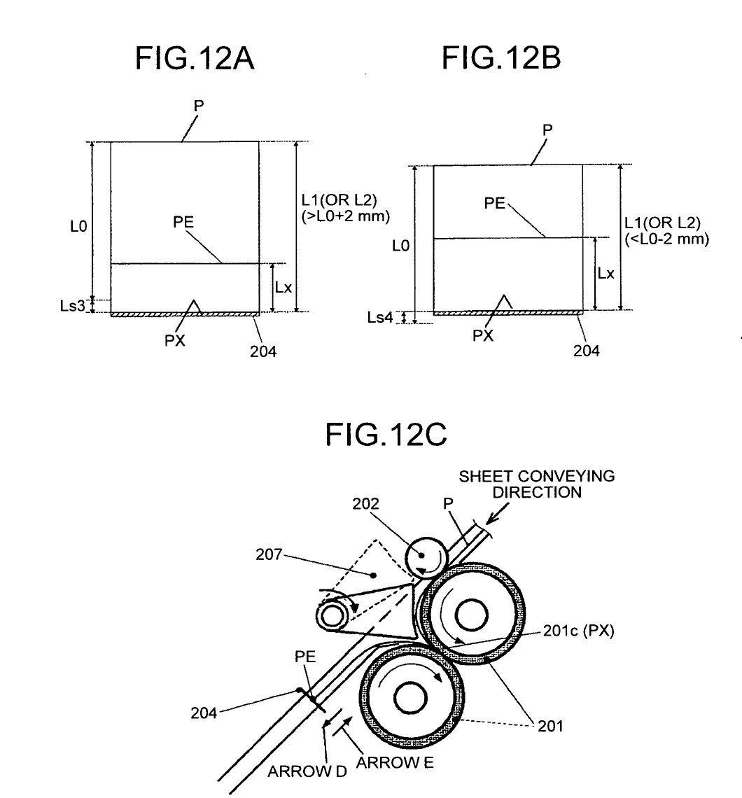

FIGS. 12A to 12C are explanatory diagrams illustrating the relation between the folding length and the leading end stopper 204. FIG. 12A illustrates a state that “folding length L1 (or L2)>reference value” when the sheet P is folded on a first try, and the sheet leading end PE is folded. FIG. 12B illustrates a state that “folding length L1 (or L2)<reference value.” FIG. 12C illustrates a position of the leading end stopper in the folding unit. As shown in FIG. 12A, in the case of

L1 or L2>L0+2 mm (Yes in step S13), folding length L1 (or L2) are reset as

L1 (or L2)−L0=Ls3 (Ls3>2 mm),

and the leading end stopper 204 is driven by the leading end stopper position adjusting driver 205 such that an abutting position of the leading end stopper 204 is moved away from the pair of folding rollers 201 by a distance Ls3 (step S14).

In the example of FIG. 12A, the folding length L1 or L2 is larger than the reference value “L0+2 mm”. That is, the first folding length Lx between the sheet leading end PE and the fold mark PX is short.

The first folding length Lx is equal to a length between the leading end stopper 204 and a nip 201c of the pair of folding rollers 201 in FIG. 12C. In order to lengthen the first folding length Lx, the leading end stopper 204 may be moved away from the pair of folding rollers 201 (the direction indicated by the arrow D in FIG. 12C).

Meanwhile, as shown in FIG. 12B, in the case that

L1 or L2<L0−2 mm (No in step S13), the position of the leading end stopper 204 is moved toward the pair of folding roller 201 by a distance Ls4 (in the direction indicated by the arrow E in FIG. 12C), that is,

L0−L1 (or L2)=Ls4 (Ls4>2 mm) (step S15).

In addition, as the process of step S14 or S15 is finished, receipt of the next sheet is allowed (step S3), and the process subsequent to step S4 is performed again.

As described above, according to the present embodiment, in addition to the angle adjustment of the first embodiment, the position of the leading end stopper 204 is controlled based on the measurement result of the folding-length measurement unit 209. Therefore, it is possible to fold the sheet at a more precise position than in the first embodiment. In this case, similar to the first embodiment, in order to fold the sheet precisely at a desired position, it is possible to make manual adjustment of the stopper position unnecessary, such as to repeatedly adjust the position of the leading end stopper by actually measuring the folded state and the like. Thus, it is possible to improve convenience.

### Third Embodiment

The first embodiment relates to an example of variably controlling the angle of the leading end stopper, and the second embodiment relates to an example of variably controlling the position in addition to the angle of the leading end stopper. In comparison, the third embodiment relates to an example of changing the moving amount of the leading end stopper according to the folding mode. Because the mechanical and electrical configurations are similar to those of the first embodiment, the same reference numerals are assigned to the same elements, and the description thereof will not be repeated.

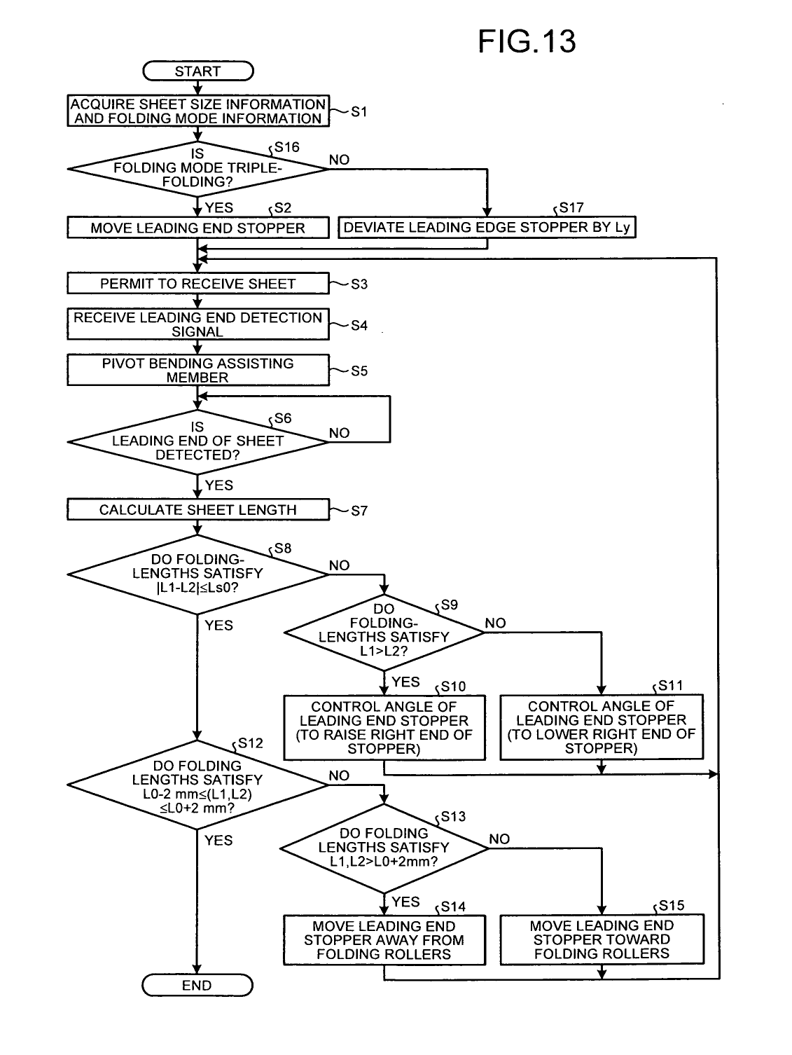

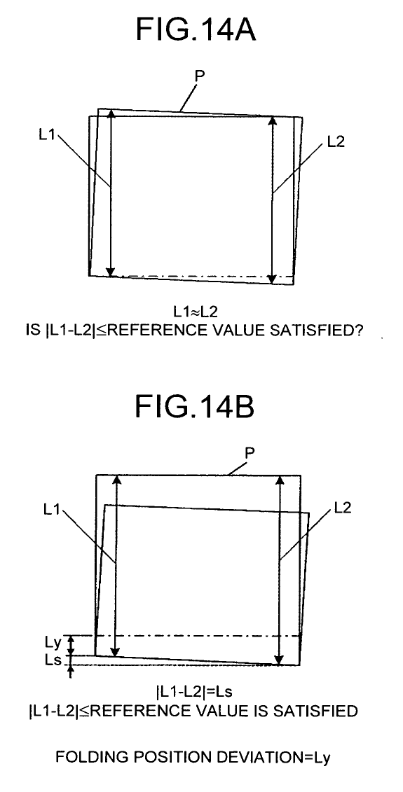

FIG. 13 is a flowchart illustrating an operational sequence of the sheet folding device according to the third embodiment. FIG. 14A and B are explanatory diagrams illustrating a state of the difference according to the present embodiment. In this flowchart, a step of determining a folding mode (step S16) and a step of moving a leading end stopper based on the determination result (step S17) are added after the step S1 of the flowchart according to the second embodiment shown in FIG. 11. Other remaining processes are similar to those described in connection with FIG. 11, and only different portions will be described in the present embodiment.

In FIG. 13, first, sheet information (sheet size: A4) and the folding mode information are acquired from the main body (step S1). In a case where the folding mode is set as triple-folding (Z-folding, inward triple-folding, or outward triple-folding) (Yes in step S16), the processes subsequent to the step S2 shown in FIG. 11 are performed.

In a case where the folding mode is set to single folding (No in step S16), the leading end stopper 204 is deviated from a typical folding position by a predetermined value Ly (step S17). In the case of single folding, the difference between the folding lengths L1 and L2 may not be determined as shown in FIG. 14A even when the folding position is inclined due to an influence of the angle of the leading end stopper 204. Therefore, as shown in FIG. 14B, first, the leading end stopper 204 is intentionally deviated by the preset value Ly to determine the influence of the angle of the leading end stopper 204.

Specifically, for example, in the case of the sheet information (sheet size: A3) and the folding mode information (single folding), single folding is performed at ½ of the longitudinal side of the A3 sheet, and the leading end stopper 204 is moved such that a distance between the leading end stopper 204 and the nip 201c becomes ½ of the longitudinal length of the A3 sheet (210 mm). However, according to the present embodiment, when the folding mode is set as single folding, the leading end stopper 204 is moved such that a distance between the leading end stopper 204 and the nip 201c of the pair of folding rollers 201 becomes, for example, 230 mm that is deviated by 20 mm (Ly) from the preset value (210 mm). In the case of single folding, correction is made in step S14 for the deviated amount in the position of the leading end stopper 204, and the processes subsequent to step S3 are repeated until the condition “folding length L1 or L2 reference value L0±2 mm” is satisfied.

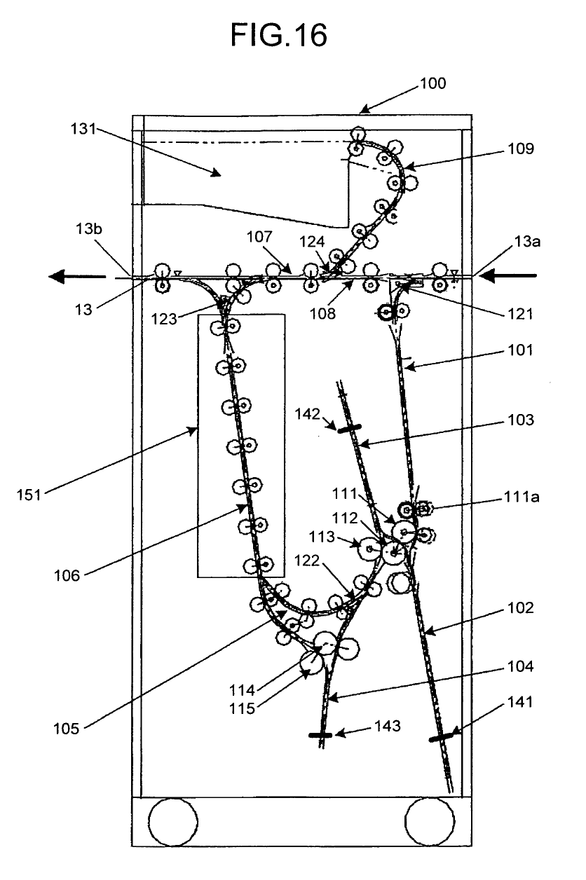

In the case of single folding of the present embodiment, the position of a first stopper 141 in FIG. 16 may be controlled.

As described above, according to the present embodiment, because the position control and the angle control of the leading end stopper 204 is changed depending on the folding mode, the control can be suitably made according to the selected folding mode even when the folding mode changes. As a result, similar to the first and second embodiments, because adjustment of the position of the leading end stopper becomes dispensable, it is possible to improve convenience.

### Fourth Embodiment

The adjustment operations of the first and second embodiments are not always performed, but may be performed according to a user's selection. For example, if the folding-length adjustment mode is selected by the operation unit 212 of the image forming apparatus PR connected to the sheet folding device 100, the folding length may be adjusted. On the contrary, if the folding-length adjustment mode is not selected, the folding-length adjustment is not performed.

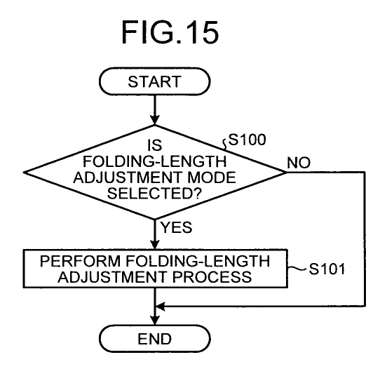

FIG. 15 is a flowchart illustrating an operational sequence accompanied by a selection operation as described above. Referring to FIG. 15, after power is on, if the folding-length adjustment mode is selected by the operation unit 212 of the main body of the image forming apparatus PR (Yes in step S100), the folding-length adjustment process described in conjunction with the first to third embodiments is performed (step S101). If the folding-length adjustment mode is not selected in step S100 (No in step S100), the folding-length adjustment process is not performed.

According to the present embodiment, if the folding-length adjustment mode is selected, the folding-length adjustment mode is performed. However, an operator or a service person may perform fine adjustment through the operation unit 212 in a normal mode while he/she looks at the folded sheet. Specifically, the angle or the position of the leading end stopper may be selected to perform fine adjustment. In the case of the angle, the stopper adjustment angle may be selected.

As described above, according to the present embodiment, because the folding-length adjustment mode can be selected, the folding length can be adjusted during the processing or product arrival as necessary. In addition, because fine adjustment can be made using the operation unit, simplicity and convenience of the adjustment can be achieved.

### Fifth Embodiment

Specifically, the sheet folding devices described in the first to fourth embodiments are provided as a device shown in FIG. 16. FIG. 16 is a diagram illustrating a schematic configuration of the sheet folding device according to the fifth embodiment.

In FIG. 16, the sheet folding device 100 is connected to the downstream of the image forming apparatus PR in FIG. 1, for example. The image forming apparatus PR may include, for example, a copying machine, a printer, a facsimile, a digital MFP having at least two functions of these in combination, and the like. For the sheet, on which an image has already been formed, being conveyed from the image forming apparatus PR, if the folding process in the sheet folding device 100 is necessary, the folding process is performed in the sheet folding device 100. If the folding process is not necessary in the sheet folding device 100, the sheet bypasses the sheet folding device 100, and is conveyed to the sheet post-processing device in the downstream. The sheet post-processing device has the same functions and mechanism as those well known in the art and is capable of, for example, punching, alignment, edge binding, center folding, center binding, sorting, and the like.

The sheet folding device 100 is provided with a horizontal conveying path for straightly discharging the sheet from the sheet inlet port to the sheet outlet port. In order to fold the sheet, the conveying direction is changed from the horizontal conveying path to the folding processing unit by a first switching claw 121, and the folded sheet is returned from a sixth conveying path 106 to the horizontal conveying path in the downstream from the position where the first switching claw 121 is provided and is discharged to the sheet post-processing device through the outlet port.

The conveying paths divided from the sheet inlet port by the first switching claw 121 include a first conveying path 101, a second conveying path 102, a third conveying path 103, a fourth conveying path 104, a fifth conveying path 105, the sixth conveying path 106, a seventh conveying path 107, an eighth conveying path 108, and a ninth conveying path 109. The first and second conveying paths 101 and 102 are divided by the nip between a first folding roller 111 and a carriage roller 111a. The second and third conveying paths 102 and 103 are divided by the second folding nip between the first folding roller 111 and a second folding roller 112. The third and fourth conveying paths 103 and 104 are divided by the second folding nip between the second folding roller 112 and a third folding roller 113. The fourth and fifth conveying paths 104 and 105 are divided by a second switching claw 122. The sixth conveying path 106 is divided by the third folding nip between fourth and fifth folding rollers 114 and 115. The seventh conveying path 107 extends from the branch point of a third switching claw 123 in the downstream side of the sixth conveying path 106 to a fourth switching claw 124 of the horizontal conveying path. The eighth conveying path 108 includes the horizontal conveying path from the first switching claw 121 to the fourth switching claw 124. The ninth conveying path 109 extends from the fourth switching claw 124 to a sheet tray 131.

The first switching claw 121 guides the sheet supplied from the sheet inlet port to one of the eighth conveying path 108 and the first conveying path 101. The second conveying path 102 connected to the first conveying path 101 in the downstream of the first conveying path 101 is provided with the first stopper 141.

In the upstream side of the second conveying path 102 (in the first conveying path 101 side), the third conveying path 103 connected to the first conveying path 101 and the second conveying path 102 described above is positioned, and the third conveying path 103 is provided with a second stopper 142. The third conveying path 103 is connected to the fourth conveying path 104 through the second folding nip between the second and third folding rollers 112 and 113. The fourth conveying path 104 is provided with the pair of carriage rollers and a third stopper 143. The first and second folding rollers 111 and 112 are provided between the upstream side of the second conveying path 102 and the upstream side of the third conveying path 103.

In the middle of the fourth conveying path 104, the sixth conveying path 106 divided from the fourth conveying path 104 is provided. The sixth conveying path 106 extends to the third switching claw 123 through a fold-enhancing roller mechanism 151 formed by a plurality of pairs of carriage rollers. The fourth and fifth folding rollers 114 and 115 forming the third folding nip are provided between the fourth and sixth conveying paths 104 and 106.

The sheet folding device according to the present embodiment includes the first to third stoppers 141, 142, and 143 as described above. In addition, although not shown in the drawings, the sheet folding device further includes the leading end stopper angle adjusting driver 210 and the folding-length measurement unit 209a and 209b in each folding unit in the vicinity of both ends of the folding conveying path. In addition, the carriage rollers are suitably arranged in positions necessary to convey the sheet in the first to ninth conveying paths 101 to 109 in order to prevent sheet from jamming.

According to the configuration described above, it is possible to perform folding operations such as single folding, Z-folding, outward triple-folding, inward triple-folding, simple four-folding, and quadruple gate folding.

In addition, overlapping folding can be performed as necessary.

Hereinafter, details of each folding operation will be described.

### Z-Folding

In the Z-folding, the sheet input from a sheet inlet port 13a is guided to the first conveying path 101 along the first switching claw 121. The sheet passes through the first folding nip between the first and second folding rollers 111 and 112, and the sheet leading end abuts on the second stopper 142 capable of moving to the folding position arranged in the third conveying path 103. As the sheet abuts on the second stopper 142, the bended portion of the sheet is inserted into the second folding nip between the second and third folding rollers 112 and 113 to perform the first folding. The sheet subject to the first folding is conveyed to the fourth conveying path 104 by being guided by the second switching claw 122. Each of the stoppers 141 to 143 is movable to a predetermined extent along the conveying path using a moving mechanism (not shown).

As the sheet leading end abuts on the third stopper 143 that can be moved to the folding position arranged in the fourth conveying path 104, the sheet is bended in the space of the upstream side from the nip between the fourth and fifth folding rollers 114 and 115, and the bended portion is inserted into the third folding nip between the fourth and fifth folding rollers 114 and 115 to perform the second folding to complete the Z-folding. The sheet subjected to the Z-folding passes through a horizontal conveying path 13 through the sixth conveying path 106 and is discharged from a sheet outlet port 13b to the sheet post-processing device in the downstream. At this moment, the third switching claw 123 is switched to the side for guiding the sheet to the sheet outlet port. As a result, a Z-folding downstream discharge process is performed. In a case where the sheet is discharged to the sheet post-processing device in the downstream, other post-processes such as punching may be performed using a sheet post-processing device.

Meanwhile, in a case where the third switching claw 123 is switched to the side for guiding the sheet to the seventh conveying path 107, the sheet arrives at the ninth conveying path 109 through the seventh conveying path 107 and the fourth switching claw 124, and is discharged to the sheet tray 131. As a result, the Z-folding sheet tray discharge process is performed.

### Single Folding

In the single folding, the input sheet is guided to the second conveying path 102 through the first conveying path 101 by the first switching claw 121. As the sheet leading end abuts on the first stopper 141 that can be moved to the folding position arranged in the second conveying path 102, the sheet is bended in the space in the upstream from the first folding nip between the first and second folding rollers 111 and 112. As the bending is progressed, the sheet is inserted into the first folding nip, and the first folding is performed in the first folding nip to complete the single folding.

After completing the folding, the sheet does not enter the third conveying path 103, but passes through the nip between the second and third folding rollers 112 and 113, is guided to the fifth conveying path 105 by the second switching claw 122 and stored in the sheet tray 131 through the sixth conveying path 106, the seventh conveying path 107, and the ninth conveying path 109. The third and fourth switching claws 123 and 124 are switched in such a way that the sixth conveying path 106, the seventh conveying path 107, and the ninth conveying path 109 are connected one another.

### Outward Triple-Folding, Inward Triple-Folding, Simple Four-Folding

In the folding operations, the input sheet is guided to the second conveying path 102 through the first conveying path 101 by the first switching claw 121. When the sheet leading end abuts on the first stopper 141 of the second conveying path 102, the sheet is bended in a similar manner to the single folding, is doubly folded in the first folding nip through the same operation, and is conveyed to the third conveying path 103. When the sheet leading end abuts on the second stopper 142 of the third conveying path 103, the bended portion of the sheet is inserted into the nip of the second and third folding rollers 112 and 113 in a similar manner to the Z-folding, and the second folding is performed.

In this case, the first and second stoppers 141 and 142 stop at the controlled positions depending on the sheet size and the folding mode such as the outward triple-folding, the inward triple-folding, and the simple quadruple-folding to set the first and second folding positions and the folding direction. After completing the second folding process, the sheet is guided to the fifth conveying path 105 by the second switching claw 122, and is stored in the sheet tray 131 through the sixth conveying path 106, the seventh conveying path 107, and the ninth conveying path 109. The third and fourth switching claws 123 and 124 are switched in such a way that the sixth conveying path 106, the seventh conveying path 107, and the ninth conveying path 109 are connected one another.

### Quadruple Gate Folding

In the quadruple gate folding, the input sheet is guided to the second conveying path 102 through the first conveying path 101 by the first switching claw 121. When the sheet leading end abuts on the first stopper 141 of the second conveying path 102, the sheet is bended in a similar manner to the single folding, folded twice in the first folding nip through the same operation, and conveyed to the third conveying path 103. When the sheet leading end abuts on the second stopper 142 of the third conveying path 103, the bended portion of the sheet is inserted into the nip between the second and third folding rollers 112 and 113 to perform the second folding as in the Z-folding.

The sheet is guided to the fourth conveying path 104 by the second switching claw 122. When the sheet leading end abuts on the third stopper 143 of the fourth conveying path 104, the bended portion of the sheet is inserted into the third folding nip between fourth and fifth folding rollers 114 and 115 and conveyed to the sixth conveying path 106 side, where the third folding is performed, and the quadruple gate folding is completed.

In the quadruple gate folding, one end side is folded at the first folding nip, and the other end side is folded at the second folding nip. Finally, the center portion is inwardly folded, and both ends are folded and inserted to the center portion, so that the so-called quadruple gate folding is completed.

After completing the folding, the folded sheet is guided to the sixth conveying path 106 and stored in the sheet tray 131 through the seventh conveying path 107 and the ninth conveying path 109. Alternately, the sheet may be conveyed to the sheet post-processing device in the downstream from the sheet outlet port instead of being stored in the sheet tray 131. In this case, the third switching claw 123 opens the conveying path connected to the sheet outlet port and closes the conveying path to the seventh conveying path 107.

In order to convey the sheet to the post-processing device in the downstream without folding, the sheet is directly discharged from the sheet outlet port by the first switching claw 121. In order to perform the folding, the sheet is guided to each conveying path inside the folding device using the first switching claw 121, and each folding operation is performed. After completing the folding, the enhancement of folding is performed using the fold-enhancing roller mechanism 151.

That is, although the single folding is completed in the first folding nip between the first and second folding rollers 111 and 112, then, the sheet passes through the nip between the second and third folding rollers 112 and 113, is guided to the fifth conveying path 105 by the second switching claw 122, and is stored in the sheet tray 131 through the sixth conveying path 106, the seventh conveying path 107, and the ninth conveying path 109. This is similar to those already described above.

As described above, according to the present embodiment, the angle adjustment and the folding position of the leading end stopper are controlled based on measurement results of the folding-length measurement unit for each folding unit and each folding mode. Therefore, it is possible to fold the sheet at an accurate position even when the folding mode changes. According to the first to fourth embodiments, because manual angle adjustment of the leading end stopper is dispensable, it is possible to improve convenience.

According to the invention, the angle of the leading end stopper is variably controlled based on measurement results of the folding-length measurement unit. Therefore, it is possible to accurately form a folding mark irrespective of a sheet conveying condition.

Although the invention has been described with respect to specific embodiments for a complete and clear disclosure, the appended claims are not to be thus limited but are to be construed as embodying all modifications and alternative constructions that may occur to one skilled in the art that fairly fall within the basic, teaching herein set forth.

What is claimed is:

1. A sheet folding device comprising:
a conveying path on which a sheet is conveyed;
a conveying unit arranged on the conveying path to convey the sheet to the downstream side in a sheet conveying direction of the conveying path;
a folding conveying path branching from the conveying path in a downstream side of the conveying unit in the sheet conveying direction to discharge a folded sheet;
a pair of folding rollers arranged in a branching portion of the folding-conveying path branching from the conveying path to fold the sheet in a nip formed between the rollers;
a leading end stopper which is arranged in a downstream from the folding roller in the sheet conveying direction and on which a leading end of the sheet is abutted to determine a folding position;
an angle adjustment unit that adjusts an angle of the leading end stopper;
a folding-length measurement unit arranged in the folding-conveying path to measure each length of both edges of the sheet that passes therethrough; and
a control unit that operates the angle adjustment unit based on the measurement result of the folding-length measurement unit to variably control the angle of the leading end stopper.

2. The sheet folding device according to claim 1, further comprising a position adjustment unit that adjusts a position of the leading end stopper,
wherein the control unit operates the position adjustment unit based on the measurement result of the folding-length measurement unit and variably controls a position of the leading end stopper.

3. The sheet folding device according to claim 1, wherein the sheet folding device operates in a plurality of folding modes including a single folding mode and a triple-folding mode, and
the control unit changes a moving amount of the leading end stopper according to a selected folding mode.

4. The sheet folding device according to claim 1, further comprising a leading end detector located at an upstream side from the leading end stopper in a sheet conveying direction to detect a leading end of the conveyed sheet,
wherein the control unit sets a folding position of the sheet based on a detected output from the leading end detector.

5. The sheet folding device according to claim 1, further comprising a leading end detector arranged at an upstream side from the leading end stopper in a sheet conveying direction to detect a leading end of the conveyed sheet,
wherein the control unit sets a position of the stopper based on a detected output from the leading end detector.

6. The sheet folding device according to claim 1, wherein a plurality of the pairs of folding rollers is provided.

7. An image forming apparatus comprising the sheet folding device that includes:
a conveying path on which a sheet is conveyed;
a conveying unit arranged on the conveying path to convey the sheet to the downstream side in a sheet conveying direction of the conveying path;
a folding conveying path branching from the conveying path in a downstream side of the conveying unit in the sheet conveying direction to discharge a folded sheet;
a pair of folding rollers arranged in a branching portion of the folding-conveying path branching from the conveying path to fold the sheet in a nip formed between the rollers;
a leading end stopper which is arranged in a downstream from the folding roller in the sheet conveying direction and on which a leading end of the sheet is abutted to determine a folding position;
an angle adjustment unit that adjusts an angle of the leading end stopper;
a folding-length measurement unit arranged in the folding-conveying path to measure each length of both edges of the sheet that passes therethrough; and
a control unit that operates the angle adjustment unit based on the measurement result of the folding-length measurement unit to variably control the angle of the leading end stopper.

8. The image forming apparatus according to claim 7, further comprising an operation unit that allows a user to select a mode for adjusting a folding length, wherein
the control unit adjusts a folding length when the mode is selected through an operation unit, and the control unit does not adjust the folding length when the mode is not selected.
